(19) United States
(12) Patent Application Publication
(10) Pub. No.: US 2024/0134601 A1
(43) Pub. Date: Apr. 25, 2024

(54) FUSED MULTIPLY-ADD LOGIC TO PROCESS INPUT OPERANDS INCLUDING FLOATING-POINT VALUES AND INTEGER VALUES

(71) Applicants: Ankur AGRAWAL, Chappaqua, NY (US); Kailash GOPALAKRISHNAN, New York, NY (US)

(72) Inventors: Ankur AGRAWAL, Chappaqua, NY (US); Kailash GOPALAKRISHNAN, New York, NY (US)

(73) Assignee: INTERNATIONAL BUSINESS MACHINES CORPORATION, Armonk, NY (US)

(21) Appl. No.: 18/054,834

(22) Filed: Nov. 11, 2022

Related U.S. Application Data
(60) Provisional application No. 63/380,233, filed on Oct. 19, 2022.

(51) Int. Cl. G06F 7/487; G06F 5/01; G06F 7/485

(52) U.S. Cl. CPC G06F 7/4876; G06F 5/012; G06F 7/485

(57) ABSTRACT

Provided are a floating-point unit, a system, and method for fused multiply-add logic to process input operands including floating-point values and integer values. A first input operand comprising an integer value and second and third input operands comprising floating-point values are received. The first, second, and third input operands are processed to produce a floating-point result.

### BACKGROUND

### 1. Field of the Invention

The present invention relates to a floating-point unit, a system, and method for fused multiply-add logic to process input operands including floating-point values and integer values

### 2. Description of the Related Art

Because computer memory is limited, it is not possible to store numbers with infinite precision, no matter whether the numbers use binary fractions or decimal fractions. At some point a number has to be cut-off or rounded-off to be represented in a computer memory.

How a number is represented in memory is dependent upon how much accuracy is desired from the representation. Generally, a single fixed way of representing numbers with binary bits is unsuitable for the varied applications where those numbers are used. A physicist needs to use numbers that represent the speed of light (about 300000000) as well as numbers that represent the Newton's gravitational constant (about 0.0000000000667), possibly together in some application.

To satisfy different types of applications and their respective needs for accuracy, a general-purpose number format has to be designed so that the format can provide accuracy for numbers at very different magnitudes. However, only relative accuracy is needed. For this reason, a fixed format of bits for representing numbers is not very useful. Floating-point representation solves this problem.

A floating-point representation resolves a given number into three main parts: (i) a significand that contains the number's digits, (ii) an exponent that sets the location where the decimal (or binary) point is placed relative to the beginning of the significand, and (iii) a sign (positive or negative) associated with the number. Negative exponents represent numbers that are very small (i.e. close to zero).

A Floating-point Unit (FPU) is a processor or part of a processor, implemented as a hardware circuit, that performs floating-point calculations. While early FPUs were standalone processors, most are now integrated inside a computer's Central Processing Unit (CPU). Integrated FPUs in modem CPUs are very complex, since they perform high-precision floating-point computations while ensuring compliance with the rules governing these computations, as set forth in IEEE floating-point standards (IEEE 754).

One common floating-point operation is a fused multiply-add (FMA) operation, which includes computing the product of two input floating point operands and adding a third input floating point operand. However, in certain computing applications, one of the input multiplicands might be an integer operand, represented as binary numbers, and the FPU might be required to perform a FMA operation on the integer operand. To perform this, incoming binary integer numbers might be first converted to floating point format, and then floating point values might be accumulated into a register (→) with two back-to-back instructions, as illustrated in an example code snippet below:
R0→Integer_to_FloatingPoint(X)
R1→R0*Y+R1 [where R0, R1 and Y are all floating point numbers] This code snippet, executed whenever a new integer operand (X) is available at the input, performs a scaled accumulation of input binary integer values.

Deep learning neural networks, also referred to as Deep Neural Networks (DNN) are a type of neural networks. The configuring and training of DNNs is computation intensive. Over the course of the training of a DNN, many floating-point computations have to be performed at each iteration, or cycle, of training. A DNN can include thousands if not millions of nodes. The number of floating-point computations required in the training of a DNN scales exponentially with the number of nodes in the DNN. Furthermore, different floating-point computations in the DNN training may potentially have to be precise to different numbers of decimal places.

Machine learning workloads tend to be computationally demanding. Training algorithms for popular deep learning benchmarks take weeks to converge on systems comprised of multiple processors. Specialized accelerators that can provide large throughput density for floating-point computations, both in terms of area (computation throughput per square millimeter of processor space) and power (computation throughput per watt of electrical power consumed), are important metrics for future deep learning systems.

### BRIEF DESCRIPTION OF THE DRAWINGS

Referring now to the drawings in which like reference numbers represent corresponding parts throughout:

FIG. 1 illustrates an embodiment of a processor chip architecture.

FIG. 2 illustrates an embodiment of an Artificial Intelligence (AI) accelerator architecture and dataflow.

FIG. 3 illustrates an embodiment of components to process inputs before processing by a Fused Multiply-Add (FMA) engine.

FIGS. 4 and 5 illustrate embodiments of FMA engines.

FIG. 6 illustrates a computing environment in accordance with certain embodiments.

### SUMMARY

Provided are a floating-point unit, a system, and method for fused multiply-add logic to process input operands including floating-point values and integer values. A first input operand comprising an integer value and second and third input operands comprising floating-point values are received. The first, second, and third input operands are processed to produce a floating-point result.

### DETAILED DESCRIPTION

Current implementations of a fused multiply-add operation when one of the operands is binary integer requires back-to-back operations of first converting the binary integer value to a floating-point value and accumulating into a register, and then performing the multiply-add operation with the register having the accumulated floating-point value.

Described embodiments provide improved computer technology for implementing the fused multiply-add (“FMA”) engine to perform the multiply-add operation in one-step when one of the input operands comprises a binary integer value, as opposed to a floating-point number, to avoid having to perform the conversion in an additional operation prior to the fused multiple-add logic.

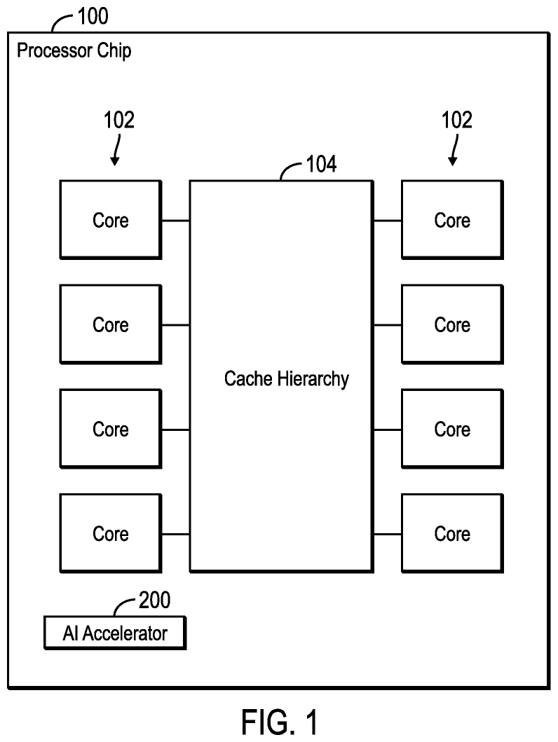

FIG. 1 illustrates an embodiment of a processor chip 100, such as an integrated circuit, having a plurality of cores 102 and a cache hierarchy 104 of memory shared by the cores 102. The processor chip 100 further includes one or many artificial intelligence (“AI”) accelerator 200. The processor chip 100 may be utilized in a server or enterprise machine to provide dedicated on-chip AI acceleration.

The AI accelerator 200 may be described as an on-chip AI accelerator 200 that enables generating real-time insights from data as that data is getting processed. The AI accelerator 200 provides consistent low latency and high throughput (e.g., over 200 TFLOPS in 32 chip system) inference capacity usable by all threads. The AI accelerator 200 is memory coherent and directly connected to the fabric like other general-purpose core to support low latency inference while meeting the system's transaction rate. A scalable architecture providing transparent access to AI accelerator functions via a non-privileged general-purpose core instruction further reduces software orchestration and library complexity as well as provides extensibility to the AI functions.

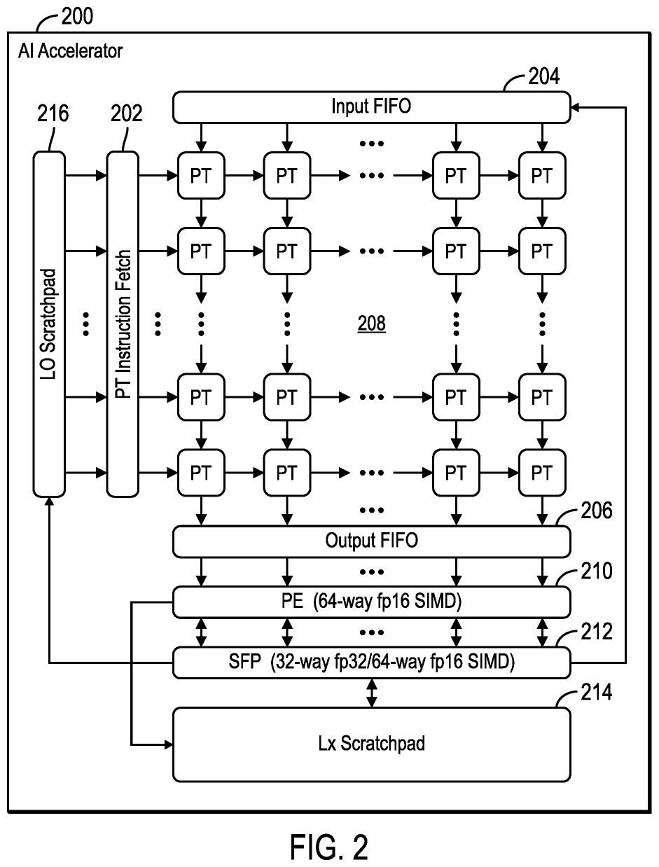

FIG. 2 illustrates an embodiment of the AI accelerator 200 architecture and dataflow in accordance with certain embodiments. The AI accelerator 200 is designed to provide enough compute performance to keep up with the maximum sustained system data bandwidth for long running systolic operations, while the performance of concurrently running virtual machines or partitions is not noticeably affected. Furthermore, the design matches the peak on-chip data bandwidth for short running elementwise or activation AI functions, and hence gets the maximum possible speed up for these functions. The microarchitecture has two main components: the compute arrays and the PT instruction fetch.

FIG. 2 presents an embodiment of the AI accelerator 200 showing a processor tile (PT) instruction fetch 202, First In First Out (FIFO) input 204 and output 206 buffers, an array of Processor Tiles (PTs) 208, Processing Elements (PEs) 210, a Special Function Processor (SFP) 212, the Lx scratchpad 214, and the LO scratchpad 216.

The PT array 208 may comprise a two-dimensional compute fabric with integer computation engines, that perform performs multiply-accumulate operations on low-precision (for example 4-bit or 8-bit integer) weights and activations, and results may be in 16-bit integer (INT16) format.

The PE 210 and SFP 212 comprises a one-dimensional compute row that accepts results from the compute fabric, and performs (a) outer loop summation/accumulations/scaling (in higher precision), (b) non-linear functions and (c) conversion back to low precision. As two-dimensional compute costs/latencies shrink and throughputs increase, the one-dimensional compute costs may become the bottlenecks.

The AI accelerator 200 may deliver more than 6 Teraflops (TFLOPS) (for FMA operations) of the FMA instruction set) per chip, which provides over 200 TFLOPS in the 32 chip system. The compute capacity comes from two separate compute arrays. Each compute array is specialized for certain types of AI operations, allowing for higher circuit customization and density as well as lower latency and power, since both compute arrays may not be in use. Discrete synchronization hardware and micro-instructions in the various engines allow for synchronization of the operations within the AI accelerator 200 and with the general purpose core that initiates the execution of Neural Network Processing Assist (NNPA) instructions.

The PT array 208, also called the matrix array, may consist of 128 Processor Tiles (PTs), which may be regarded as organized as 8 rows of 16 Processor Tiles each. Each row is elementwise connected to the row below. The top row if fed by the second compute array, allows data pre-processing on these inputs, and the bottom row returns results to the second compute array. A second stream of data is provided to the matrix array from the west side (via the LO scratchpad 216 and the PT Instruction Fetch 202) and ripples through a Processor Tile row to support efficient 2D-data computation. This compute array is used, for instance, to implement highly efficient matrix multiplication or convolution operations. Each Processor Tile may implement an eight-way Single Instruction/Multiple Data (SIMD) engine optimized for multiply-accumulate operations. It contains a local register file sized to cover the pipeline depth of the engine and to store a subset of weights for some AI operations.

The second array is the data processing and activation array, which may consist of 32 processor tiles organized as two rows of 16 engines. One row consists of engines named Processing Elements (PEs). These PEs may comprise 64-way FP16 (16-bit floating-point) SIMD engines focused on area and power efficient implementation for arithmetic, logical, look-up and type conversion functions and output to the LX scratchpad or the row of SFPs below it. The other row consists of 16 engines named Special Function Processors (SFPs). The SFP engine may be a superset of the PE. The SFPs may comprise 32-way fp32/64-way fp16 SIMD. The SFP also supports horizontal operations, such as shifting left/right across engines or computing a sum-across all elements of all SFP engines. This compute array may be used either exclusively for all non-systolic functions or for data preparation and gathering for systolic functions.

In certain embodiments, the AI accelerator 200 data flow starts with intelligent data prefetch, which loads data into the LO scratchpad 216 that stages data for the PT array 208 (e.g., a 512 KiloByte (KB) scratchpad). The scratchpad 216 may be organized in multiple sections to enable double-buffering of data and compute streams to allow overlapping of prefetching, compute and write-back phases to maximize parallelism within the accelerator and increase the overall performance. The translated physical addresses for input and output data are provided by the firmware running on the cores 102. Data from the LO scratchpad 216 arrives at the PT compute engines 208 in the format and layout required by the AI operation executed. If needed, additional data manipulation is done by the complex function compute array (PE 210/SFP 212) before sending data to the PT compute engines 208 directly via the Input FIFO 204 or through the LO scratchpad 216. The results are collected from the Lx scratchpad 214 by the writeback engine and stored back to the caches 104 or memory.

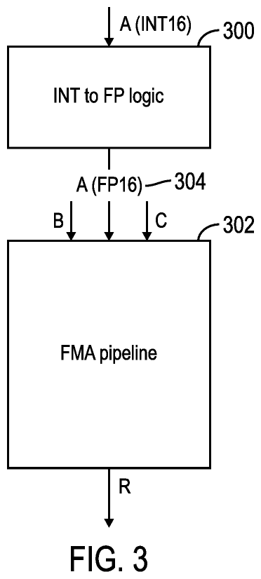

FIG. 3 illustrates an embodiment of a hardware implementation of components to process inputs A, B, C before the FMA engine. In one embodiment of this instruction, an INTEGER (INT)-to-FLOATING-POINT (FP) logic block 300 is added preceding the fused multiply-add (FMA) pipeline 302. The INT-to-FP logic block 300 converts A from an INT16 format to a FP16 format 304 so that all the inputs A, B, C to the FMA pipeline 302 are floating-point numbers and the computation proceeds through a fused multiply-add (FMA) pipeline 302 to perform a multiply-add of A*B+C.

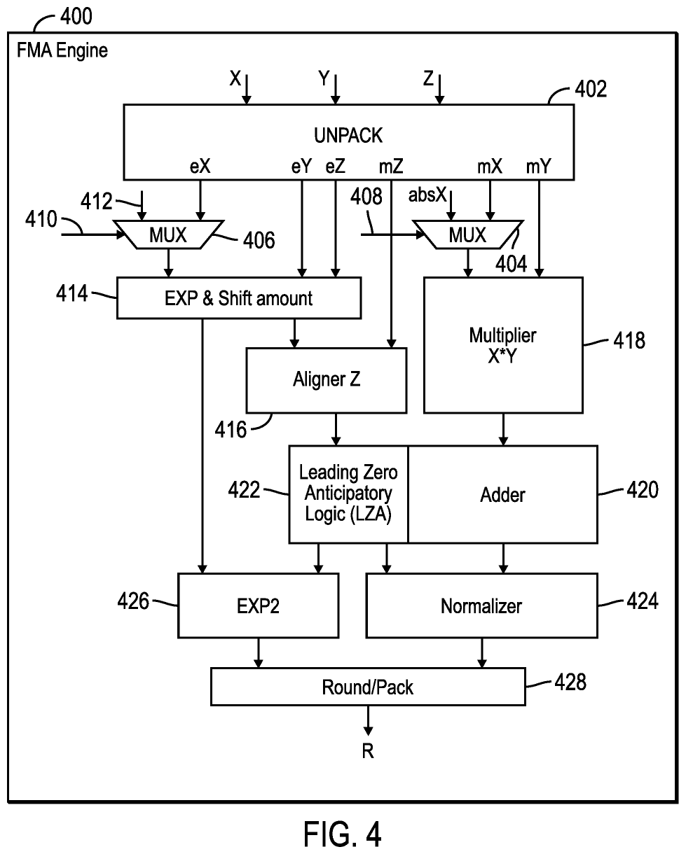

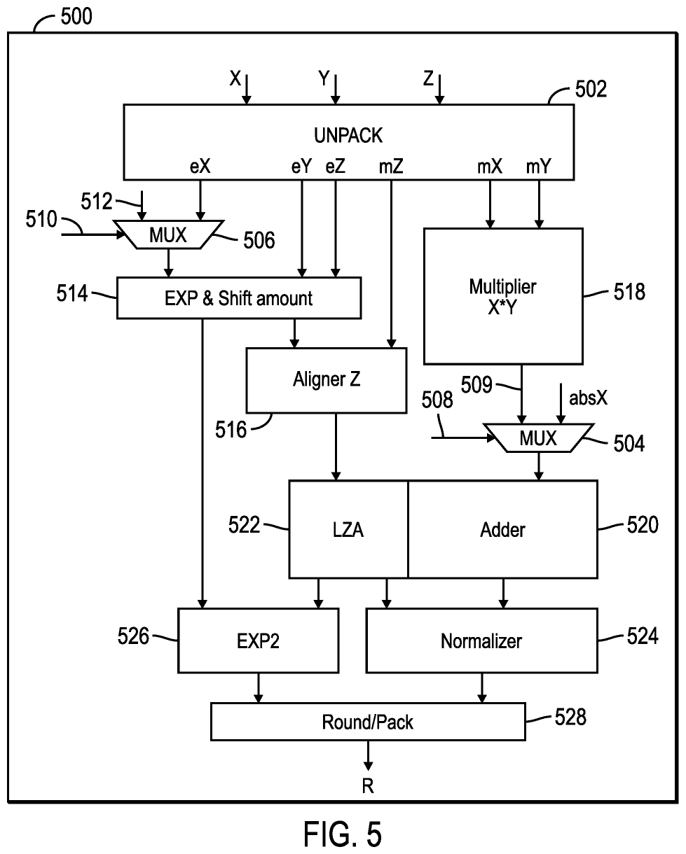

FIGS. 4 and 5 illustrate embodiments of FMA engines 400, 500, respectively, where the conversion of incoming INT16 numbers for an FMA operation to FP16 may be done in one instruction of the form:

R1→R1+X*Y,

where X is an INT16 value coming from the N-fifo, and R1 is a register containing a FP16 value, Y is an FP16 number with or without constraints.

FIG. 4 illustrates an embodiment of an FMA engine 400, which may be implemented in the processing tiles of the PT array 208. The FMA engine 400 converts incoming INT16 numbers to FP16 in one instruction of the form R═X*Y+Z, where:
R, Z, Y are floating-point numbers, and
X is an integer number.

In this way, there is an FP16 FMA instruction where one of the multiplicands (X) is an INT16 value. While the examples illustrate the case when the input and output operands are 16-bits wide, the invention is applicable to input and output bit-widths of arbitrary values. For example, the FMA engine 400 may receive as inputs X, which may be INT16, Y may be FP16, and R1 may contain an FP32 value. In other embodiments, X may comprise INT32, Y may be FP32 and R1 may contain an FP32 value.

To perform the conversion when X may be an integer, the FMA engine 400 unpack unit 402 unpacks the signs, exponents (e) and mantissas (m) of X, Y, and Z received from a pipeline. However, X may not have an exponent or mantissa when X comprises a binary integer. To address this possibility, multiplexers 404 and 406 are introduced into the pipeline. Multiplexer (MUX) 404 selectively chooses between the mantissa of X (mX) when X is a floating-point number and an absolute value of X (absX) when X comprises a binary integer number. When X comprises a binary integer, control signal 408 instructs multiplexer 404 to output the absX and control signal 410 causes multiplexer 406 to output a hardcoded value signal 412, such as 2¹⁴. When X comprises a floating-point number, control signal 408 instructs multiplexer 404 to output the mantissa of X (mX) and control signal 410 causes multiplexer 406 to output the exponent of X (eX).

During FMA computation, when all inputs are floating-point numbers, the control signal 408 is configured to cause multiplexer 404 to pass mX to the multiplier. During the computation of R=X*Y+Z when X is an integer, the control signal 408 is configured to pass absX to the multiplier 418. In this mode, the multiplier multiplies the absolute value of the integer number X and the mantissa of floating-point number Y.

Multiplexer 406 selectively chooses between the exponent of X (ex) and a signal 412 that is configured as a hard-coded quantity based on the bit-width of X, based on the control signal 410. During regular FMA computation, when all inputs are floating-point numbers, the control signal 410 is configured to cause the multiplexor 406 to pass eX to the exponent (EXP) and shift amount logic 414. During the computation of R=X*Y+Z when X is a floating-point, the control signal 410 is configured to pass signal 412 to the EXP and shift amount logic 414.

The exponent (EXP) and shift amount logic 414 compares sum of eX+eY to eZ to determine a shift amount and aligner Z 416 shifts the Z value depending on the magnitude and direction of the shift amount. Multiplier 418 performs multiplication of mY and absX or mX depending on the control signal 408. Adder 420 adds result of multiplication of X*Y to Z. The Leading Zero Anticipatory (LZA) logic 422 predicts the most significant bit location of the floating-point addition from the inputs (X*Y and Z) to the adder 420. This determination is performed as part of the normalization shift performed by a normalizer 424 and exponent 2 (EXP2) logic 426. The normalizer 424 produces the mantissa of the results of the fused-multiple-add operation and the EXP2 logic 426 produces the exponent field of the result. The round/pack logic 428 performs the rounding of the result (R) if the normalizer 424 provides additional bits.

With the embodiment of FIG. 4, a floating-point unit incorporating a new fused-multiply-add instruction allows one of the multiplicands to be an integer value, the other multiplicand to be floating-point number, the addend to be a floating-point number, and produces a floating-point result.

FIG. 5 illustrates an alternative embodiment of an FMA engine 500 that introduces a constraint on the Y operand for a very efficient hardware implementation in the FMA engine 500. The FMA engine 500 implements the FMA operation of:

R=X*Y+Z, where:
R, Z are floating-point numbers
X is an integer number
Y is a power of 2 (for example, −0.5, +1.0, or +4.0) represented as a floating-point number (i.e. its mantissa bits are all zero).

Limiting a second multiplicand to be a power of two enables very low-overhead functionality augmentation to a regular floating-point fused multiply-add unit, because the mantissa multiplier is bypassed.

In certain implementations, a 16-bit pipeline (i.e. X, Y, Z, and R are 16-bits wide) with 9-bit mantissas, the multiplier 518 may have 10-bit inputs. This is insufficient when X is an INT16 quantity. To avoid having to input absX into the multiplier 518 when X is an INT16 quantity, the FMA engine 500 may set Y to be a power of 2, mY becomes 1.0 and the multiplier 518 can be bypassed, since the result of the multiplication is X*1.

To perform the conversion when X may be an integer, the FMA engine 500 unpack unit 502 unpacks the signs, exponents (e) and mantissas (m) of X, Y, and Z received from a pipeline. However, X may not have an exponent or mantissa when X comprises a binary integer. To address this possibility, multiplexers 504 and 506 are introduced into the pipeline. The multiplexer 504 selectively chooses between the output 509 of the multiplier 518 and the absolute value of X (absX) based on control signal 508. During regular FMA computation, when all inputs are floating-point numbers, the control signal 508 is configured to cause multiplexer 504 to output 509 (mX*mY) from the multiplier 518 to the adder 520. When X is a binary integer, the control signal 508 is configured to cause the multiplexer 504 to pass absX to the adder 520. Compared to FMA engine 302, FMA engine 500 does not require a wider multiplier to support wider value for X because the multiplier 518 is bypassed when X comprises an integer because the multiplexer 404 outputs the absolute value of X (absX).

Multiplexer 506 selectively chooses between eX if X is a floating-point value and a hardcoded value signal 512 if X is an integer, such as a quantity based on the bit-width of X, e.g., 2¹⁴ if X is an integer. When X comprises an integer, control signal 510 causes multiplexer 506 to output a hardcoded value signal 512, such as 2¹⁴, to the EXP and shift amount logic 514 When X comprises a floating-point number control signal 510 causes multiplexer 506 to output the exponent of X (eX) to the EXP and shift amount logic 514. The remainder of the pipeline of FMA engine 500, including components 514, 516, 520, 522, 524, 526, and 528 operates as described with respect to the corresponding components 414, 416, 420, 422, 424, 426, and 428 of FMA engine 400 (FIG. 4).

In a further embodiment to simplify the instruction set architecture (ISA), B could be limited to be +1.0 (represented as a floating-point number). In this case the operation is: R→Z+X.

This instruction could have its own opcode, or the standard FMA instruction can have a bit that signals whether or not to treat X as floating-point (standard FMA) or integer.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

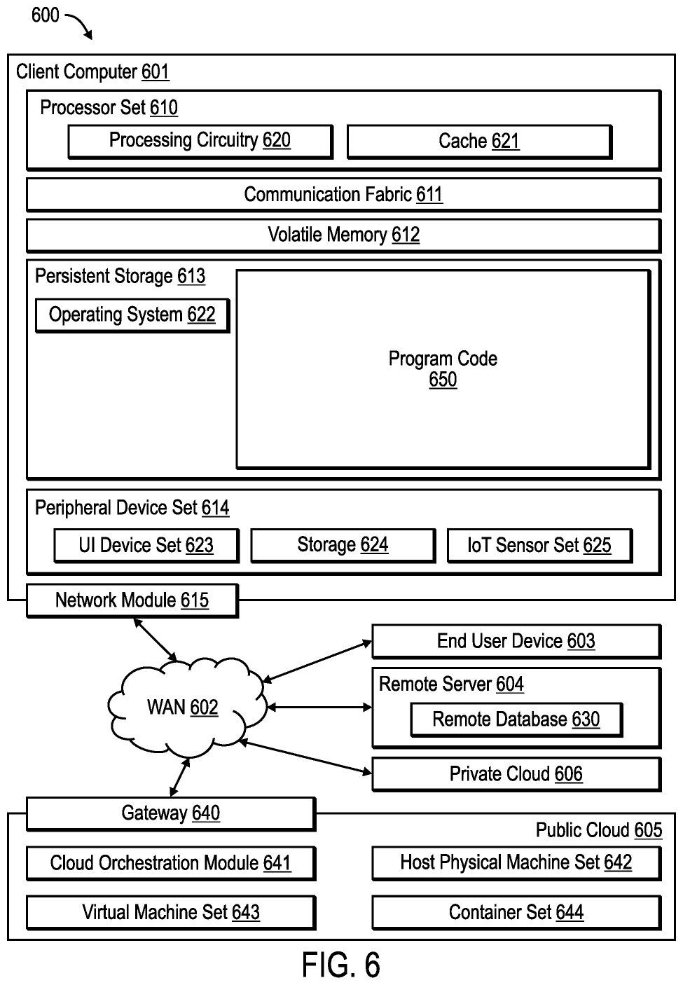

FIG. 6 illustrates a computing environment 600 in accordance with certain embodiments. Computing environment 600 contains an example of an environment for the execution of at least some of the computer code 650 to interact with the AI accelerator 200 for deep learning neural network operations. k. The computing environment 600 includes program code 650 for execution. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610, such as the processor chip 100, where the processing circuitry 620 may include the AI accelerator 200 of FIGS. 1 and 2, communication fabric 611, volatile memory 612, persistent storage 613 (including operating system 622 and program code 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may comprise the processor chip 100 and AI accelerator 200 of FIGS. 1 and 2. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 103. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

### Additional Embodiment Details

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended.

The foregoing description provides examples of embodiments of the invention, and variations and substitutions may be made in other embodiments.

1. A floating-point unit incorporating functionality to enable a fused multiply-add instruction, comprising:
logic to receive a first input operand comprising an integer value and second and third input operands comprising floating-point values; and
fused multiply-add logic to process the first, second, and third input operands to produce a floating-point result.

2. The floating-point unit of claim 1, further comprising:
logic to receive a floating-point value for the first input operand, wherein in response to the first input operand comprising the floating-point value, the fused multiply-add logic processes the first, second, and third input operands to produce the floating-point result.

3. The floating-point unit of claim 2, wherein the fused multiply-add logic further performs:
selecting an exponent of the first input operand to output in response to the first input operand comprising the floating-point value; and
selecting a hardcoded value to output for the first input operand in response to the first input operand comprising the integer value.

4. The floating-point unit of claim 3, wherein the selected exponent of the first input operand or the selected hardcoded value are inputted to shift amount logic to determine an amount to shift the third input operand.

5. The floating-point unit of claim 3, further comprising a multiplexer to perform the selecting the exponent and the selecting the hardcoded value depending on whether the first input operand comprises the integer value or the floating-point value.

6. The floating-point unit of claim 2, wherein the fused multiply-add logic further performs:
selecting a mantissa of the first input operand to output to a multiplier in response to the first input operand comprising the floating-point value; and
selecting an absolute value of the first input operand to output for the first input operand in response to the first input operand comprising the integer value.

7. The floating-point unit of claim 6, wherein the multiplier multiplies one of the selected absolute value of the first input operand and the selected mantissa of the first input operand with the mantissa of the second input operand.

8. The floating-point unit of claim 6, further comprising a multiplexer to perform the selecting the mantissa of the first input operand and the selecting the absolute value of the first input operand depending on whether the first input operand comprises the integer value or the floating-point value.

9. The floating-point unit of claim 2, wherein the fused multiply-add logic further performs:
selecting an output of a multiplier multiplying a first mantissa of the first input operand and a second mantissa of the second input operand to output in response to the first input operand comprising the floating-point value; and
selecting an absolute value of the first input operand to output in response to the first input operand comprising the integer value.

10. The floating-point unit of claim 9, wherein the selected output of the multiplier or the selected absolute value is inputted to an adder to add to the third input operand.

11. The floating-point unit of claim 9, wherein the second input operand inputted to the multiplier is limited to a power of two in response to the first input operand comprising the integer value and the multiplier being bypassed to output the absolute value of the first input operand.

12. A system, comprising:
a plurality of processing cores;
a cache memory; and
a plurality of artificial intelligence accelerators that produce artificial intelligence processing results to return to the cache memory for processing by the processing cores, wherein the artificial intelligence accelerators include a plurality of processing tiles having floating-point units incorporating functionality to enable a fused multiply-add instruction, wherein a floating-point unit of the floating-point units comprises:
logic to receive a first input operand comprising an integer value and second and third input operands comprising floating-point values; and
fused multiply-add logic to process the first, second, and third input operands to produce a floating-point result.

13. The system claim 12, further comprising:
logic to receive a floating-point value for the first input operand, wherein in response to the first input operand comprising the floating-point value, the fused multiply-add logic processes the first, second, and third input operands to produce the floating-point result.

14. The system of claim 13, wherein the fused multiply-add logic further performs:
selecting an exponent of the first input operand to output in response to the first input operand comprising the floating-point value; and
selecting a hardcoded value to output for the first input operand in response to the first input operand comprising the integer value.

15. The system of claim 13, wherein the fused multiply-add logic further performs:
selecting a mantissa of the first input operand to output to a multiplier in response to the first input operand comprising the floating-point value; and
selecting an absolute value of the first input operand to output for the first input operand in response to the first input operand comprising the integer value.

16. The system of claim 13, wherein the fused multiply-add logic further performs:
selecting an output of a multiplier multiplying a first mantissa of the first input operand and a second mantissa of the second input operand to output in response to the first input operand comprising the floating-point value; and
selecting an absolute value of the first input operand to output in response to the first input operand comprising the integer value.

17. A method for performing a fused multiply-add instruction, comprising:
receiving a first input operand comprising an integer value and second and third input operands comprising floating-point values; and
processing the first, second, and third input operands to produce a floating-point result.

18. The method of claim 17, further comprising:
receiving a floating-point value for the first input operand, wherein in response to the first input operand comprising the floating-point value, processing the first, second, and third input operands to produce the floating-point result.

19. The method of claim 18, further comprising:
selecting a mantissa of the first input operand to output to a multiplier in response to the first input operand comprising the floating-point value; and
selecting an absolute value of the first input operand to output for the first input operand in response to the first input operand comprising the integer value.

20. The method of claim 18, further comprising:
selecting an output of a multiplier multiplying a first mantissa of the first input operand and a second mantissa of the second input operand to output in response to the first input operand comprising the floating-point value; and
selecting an absolute value of the first input operand to output in response to the first input operand comprising the integer value.
